(19) United States
(12) Patent Application Publication
(10) Pub. No.: US 2009/0084230 A1
(43) Pub. Date: Apr. 2, 2009

(54) DUAL ACTION TORQUE WRENCH

(76) Inventor: Thomas Drennan Selgas, Garland, TX (US)

Correspondence Address: CARR LLP, 670 FOUNDERS SQUARE, 900 JACKSON STREET, DALLAS, TX, 75202, US

(21) Appl. No.: 12/141,886

(22) Filed: Jun. 18, 2008

Related U.S. Application Data
(60) Provisional application No. 60/944,722, filed on Jun. 18, 2007.

(51) Int. Cl. B25B 23/14; B25B 17/00

(52) U.S. Cl. 81/467; 81/57

(57) ABSTRACT

A tool is provided having a body comprising a first receptacle for applying torque mounted to the body and a second receptacle for receiving torque mounted to the body and spaced from the first receptacle. Two or more gears rotably couple the first receptacle to the second receptacle so that an application of torque to the second receptacle results in a transfer and amplification of that torque at the first receptacle. The two or more gears may be rotably coupled so that a rotation in a first direction of a driving gear rotates an odd number of intermediate gears which in turn rotate a driven gear in the first direction. The two or more gears may be connected by intermeshed gear teeth or a chain. Pin members may secure the body from rotation while torque is applied to the second receptacle.

### CROSS-REFERENCE TO RELATED APPLICATIONS

This application relates to, and claims the benefit of the filing date of, co-pending U.S. provisional patent application Ser. No. 60/944,722 entitled DUAL ACTION TORQUE WRENCH, filed Jun. 18, 2007, the entire contents of which are incorporated herein by reference for all purposes.

### BACKGROUND OF THE INVENTION

1. Field of the Invention

The present invention relates to a torque wrench particularly to an offset torque box ratchet wrench.

2. Description of the Related Art

Conventional ratchet tools typically require direct access between the head of the tool where torque is applied about a rotational axis and a torque receiving unit such as a nut or a bolt having its own rotational axis. Torque is often applied to the bolt by manual rotation of a handle connected to the head of the tool. Torque is a measurement of twisting ability as a force is applied about an axis at a distance. The general formula for torque is then stated:

Torque(T)=force(F)*radius(R)

Typically, the axis of rotation of the head of a conventional ratchet tool must be lined up with the axis of rotation of the bolt. Often access of the head of the tool to the target bolt is obstructed because of environmental structure that surrounds the target bolt. Also, rotation of the handle may be restricted by the same environmental structure. Even where an extension member is used there may not be a direct path to line up the head of the tool to the target bolt. Thus, conventional ratchet tools cannot always access the target bolt because of the size of the tool and the need for space to rotate the handle prevent the tool from operating where there are structural obstructions.

What is needed is a tool that will transfer torque to a torque receiving unit that is located in an environment where access to the unit is limited.

### SUMMARY OF THE INVENTION

A ratchet tool is provided, comprising a head portion having a first receptacle which may transfer and amplify torque from a second receptacle where the first receptacle is offset from the second receptacle and rotably coupled by a linkage feature.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an isometric view of one embodiment of the dual action torque wrench;

FIG. 2 is a side view of the dual action torque wrench of FIG. 1;

FIG. 3 is a top view of the dual action torque wrench of FIG. 1 with portions of the body cut away to view the linkage feature;

FIG. 4 is an illustration of gears which are not configured to amplify an input torque;

FIG. 5 is an illustration of gears which are configured to amplify an input torque;

FIG. 6 is an illustration an alternative embodiment of the dual action torque wrench having a linkage feature comprised of a chain;

FIGS. 7A, 7B, 7C, 7D, and 7E are respectively top and side views (7A) of five embodiments of the socket insert; a side view (7B) and partial cut away top view (7C) of one embodiment of the first receptacle; and a side view (7D) and a partial cut away top view (7E) of an alternative embodiment of the first receptacle; and

FIG. 8 is an illustration of four top views of embodiments of the dual action torque wrench where the head portion size and bore size of the socket insert are varied.

### DETAILED DESCRIPTION

Specific examples of components, methods, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

The present invention is directed to a tool 100 which may be operated by a user as a torque wrench and provide access to torque receiving units located in environments where access to the unit is limited by obstructions. Further, the tool 100 may include torque amplification features which may increase the input torque by some factor through the use of multiple gears or other torque amplification machines.

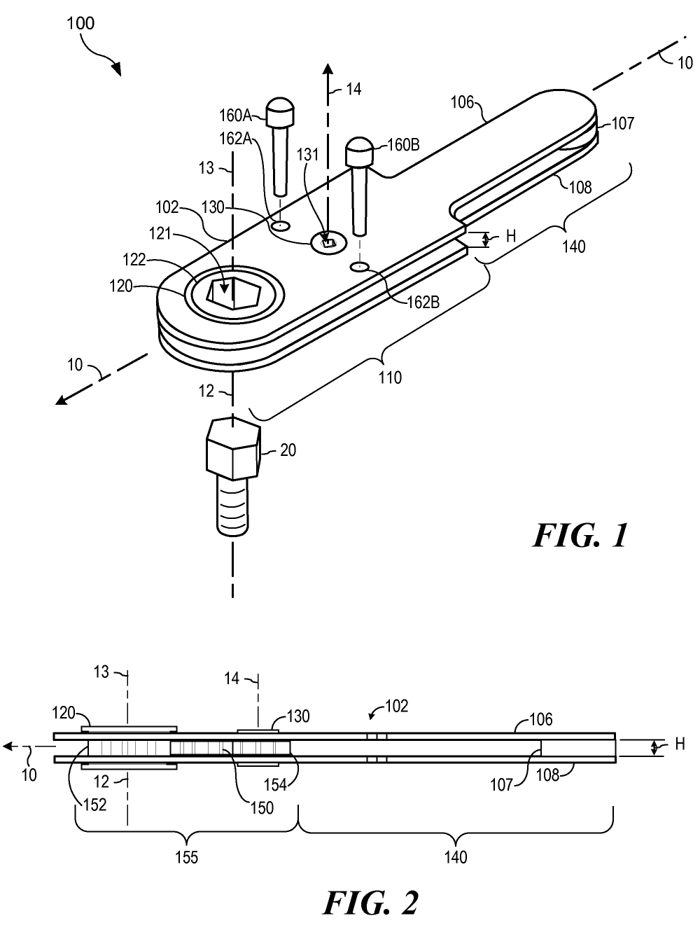

Shown in FIG. 1 is one embodiment of the tool 100 as a dual action torque wrench in the form of an offset torque box ratchet wrench which may transfer torque to a target bolt 20 by a first and second torque action. The first torque action may be a circumferential force applied to the head of the target bolt 20 as a result of the second torque action, which in some embodiments may be a rotation of a standard ratchet handle (not shown) coupled to the tool 100. The work done by the second torque action may be transferred through use of a linkage feature 155 (not shown) to the bolt 20, where the rotational axis 12 of the target bolt 20 may be offset from the rotational axis 14 of the second receptacle 130. Thus, the second torque action acts as an input resulting in the first torque action, an output; the linkage feature 155 may act to displace the line of action of the second torque action from the first torque action.

In some embodiments, the tool 100 may comprise anti-rotational features in order to counteract reactive forces, from friction for instance, which may result from attempts to rotate a bolt 20. These reactive forces may have a tendency to rotate the tool 100 while the tool 100 is in use. In FIG. 1, the anti-rotational features may comprise manual drop in pins 160A and 160B which are received by bores 162A and 162B in the body 102 of the tool 100. These pins 160A and 160B may constrain rotational movement of the tool 100 about the rotational axis of the bolt 20. In other embodiments not shown, rotational movement of the tool 100 may be constrained by an adjustable clamping bracket alone or in combination with the pins 160A and 160B or other suitable holding devices. In some embodiments, the clamping bracket (not shown) may be fitted over the handle portion 140 of the tool 100 for securing the tool 100 to a work piece for preventing rotation of the tool, in combination with or as an alternative to using the manual drop-in pins 160A and 160B for anti-rotational clamping.

The tool 100 may comprise a body 102 generally extending along a longitudinal axis 10. The body 102 may comprise a partially hollow shell and may be constructed of steel or other hardened metal. A person of ordinary skill in the art would recognize that the tool may be constructed of any number of materials. Other components of the tool 100 as well may be constructed of similar materials.

The tool 100 may further comprise a head portion 110 having a first receptacle 120 for receiving a socket insert 122 and a second receptacle 130 for coupling to a ratchet drive apparatus (not shown). The first and second receptacle may be configured to rotate about an axis, 13 and 14, respectively. The first receptacle 120 may be offset from the second receptacle 130 along a longitudinal axis 10. The linkage feature 155, as shown and described in FIG. 2, may rotably couple the first receptacle 120 to the second receptacle 130.

Referring to FIG. 1, the body 102 may comprise a shell encasing at least the linkage feature 155. The body 102 may be comprised of two generally parallel members which are generally the same dimensions to comprise a first member 106 and a second member 108 to the tool 100. In the some embodiments, the first member 106 and the second member 108 may be generally flat.

A bore 121 of the first receptacle 120 and a bore 131 of the second receptacle 130 may pass from the surface of the first member 106 through to the surface of the second member 108 and may maintain the same shape throughout. The bores 121 and 131 passing through from the first member 106 to the second member 108 may allow for the tool 100 to be flipped by the user and used with either the first member 106 towards the bolt 20 or with the second member 108 towards the bolt 20. In the embodiment shown in FIG. 1, the tool 100 may be oriented such that the second member 108 may be facing toward the bolt 20. In the configuration shown in FIG. 1 or where the tool is flipped about the longitudinal axis by 180 degrees, the tool 100 may actuate the bolt 20.

Turning now to FIG. 2, the first member 106 of the tool 100 and the second member 108 of the tool 100 may be displaced generally along the axes of rotation of the first receptacle and second receptacle to comprise a height dimension H. The height dimension H provides for volume between the first member 106 and the second member 108 where the linkage feature 155 may be located. In some embodiments, the height H may be relatively small in order to make the tool 100 slim enough to fit in confined spaces. A spacer 107 may at least partially support and couple the first member to the second member.

The handle portion 140 may extend generally longitudinally away along the axis 10 from the head portion 110 allowing for manipulating the tool into position to engage, for example, an obstructed bolt 20 such that the axis of rotation 13 of the first receptacle may be coincident with the axis of rotation of the bolt 12. The first receptacle 120 may be positioned along the longitudinal axis 10 between the second receptacle 130 and the handle portion 140. The handle portion 140 may be configured to allow for gripping and may include gripping features such as rubber cover (not shown).

As shown in FIG. 2, first member 106 and second member 108 are coupled at spacer 107 to provide support and volume to the tool 100. Also, the first receptacle 120 and the second receptacle 130 may provide additional support to the tool 100.

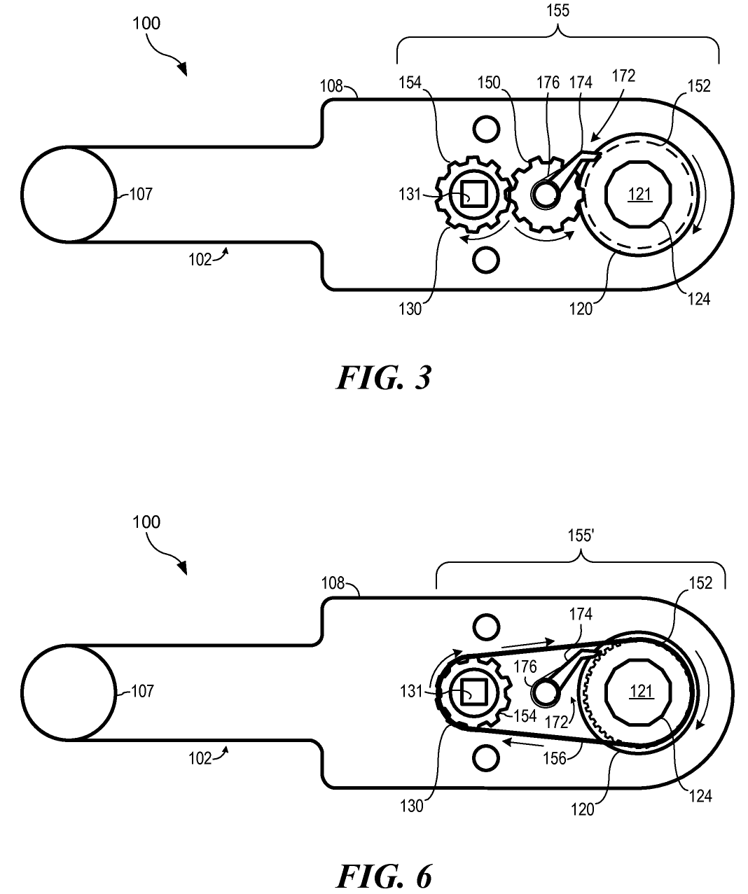

Illustrated schematically in FIG. 3 is an example of the tool 100, with linkage feature 155, comprising an intermediate gear 150, a first drive gear 152, and a second drive gear 154 of varying diameters rotably coupled together in some embodiments via interlocking teeth. Some portions of the body 102 are removed in FIG. 3 in order to illustrate the rotational coupling between the first receptacle 120 and the second receptacle 130. The first receptacle 120 may be configured with the first drive gear 152 configured to couple to the intermediate gear 150 or set of intermediate gears. The first receptacle 120 may provide a rotational hub for the first drive gear 152. The first receptacle 120 may be configured with a pocket 124 for receiving a socket insert 122 (as shown in FIG. 1) which may couple to the bolt 20 (as shown in FIG. 1) or other torque receiving unit such as a socket or ratchet extension.

The second receptacle 130 may be configured with the second drive gear 154 configured to couple to the intermediate gear 150 or set of intermediate gears (not shown). The second receptacle 130 may provide a rotation hub for the second drive gear 154. The second receptacle 130 may be configured with a torque transfer feature such as the bore 131 for receiving a ratchet tool or other torque transfer device.

The intermediate gear 150 may connect the first drive gear 152 to a second drive gear 154. In the embodiment shown in FIG. 3, the teeth of the intermediate gear 150 may mesh with the teeth of the first drive gear 152 and the teeth of the second drive gear 154. The embodiments of various gears shown in FIG. 3 are shown for illustrative purposes.

The first torque action of the tool 100 may be achieved by using the first drive gear 152 and second drive gear 154 in combination with an intermediate gear 150. It is to be understood that more than one intermediate gear 150 may be used. The gears 150, 152, and 154 may be coupled together to transfer torque between each other in one or more of the following manners:

1. Via interlocking teeth (as shown in FIG. 3);

2. Via chain (as will be described in FIG. 6);

3. Combination of chain and interlocking teeth (not shown).

Referring again to FIG. 3, the second torque action of the tool 100 may be achieved through a conventional offset handle, such as of a ratchet drive apparatus (not shown). The bore 131 of the second receptacle 130 is configured to receive a torque transfer feature of the ratchet tool. The second receptacle 130 may accept different shaped torque transfer members and adapters from the ratchet tool depending on the shape of the bore 131. It is to be understood by persons of ordinary skill in the art that the bore 131 may be configured with removable adapters or in a permanent configuration such that the bore 131 is a male rather than female connector. FIG. 3 illustrates that the second receptacle 130 may be shaped to receive a generally square shaped torque transfer member.

A ratchet drive apparatus (not shown) may be coupled to the second receptacle 130 to directly drive the second drive gear 154, which may be rotably coupled to the intermediate gear 150. The intermediate gear 150 may be rotably coupled to the first drive gear 152 of the first receptacle 120 in which the socket insert 122 may be received, as shown in FIG. 1. When the socket insert 122 of the first receptacle 130 is coupled to the obstructed bolt 20, the bolt 20, as shown in FIG. 1, may be rotated by a rotation of the second drive gear 152 of the second receptacle 120 which may have a rotational axis 14 offset from the rotational axis 12 of the bolt 20, as shown in FIG. 1.

Referring again to FIG. 3, the function of the intermediate gear 150 may be to extend the offset of the first receptacle 120 from the second receptacle 130. The intermediate gear 150 may act as an idler gear creating space between the first drive gear 152 and the second drive gear 154 while also transferring torque between the two gears 152 and 154. It should be understood by a person of ordinary skill in the art that an increase of the number of intermediate gears 150 may provide for a greater amount offset between the first receptacle 120 and the second receptacle 130 and provide greater ability to access torque receiving units, such as the bolt 20 (as shown in FIG. 1).

In addition, it should be understood by a person of ordinary skill in the art that the linkage feature 155 may include other features not shown here to extend the length of the linkage feature along the longitudinal axis 10. This may provide an option to the user to extend the body along the longitudinal axis 10 to increase the reaching ability of the tool 100.

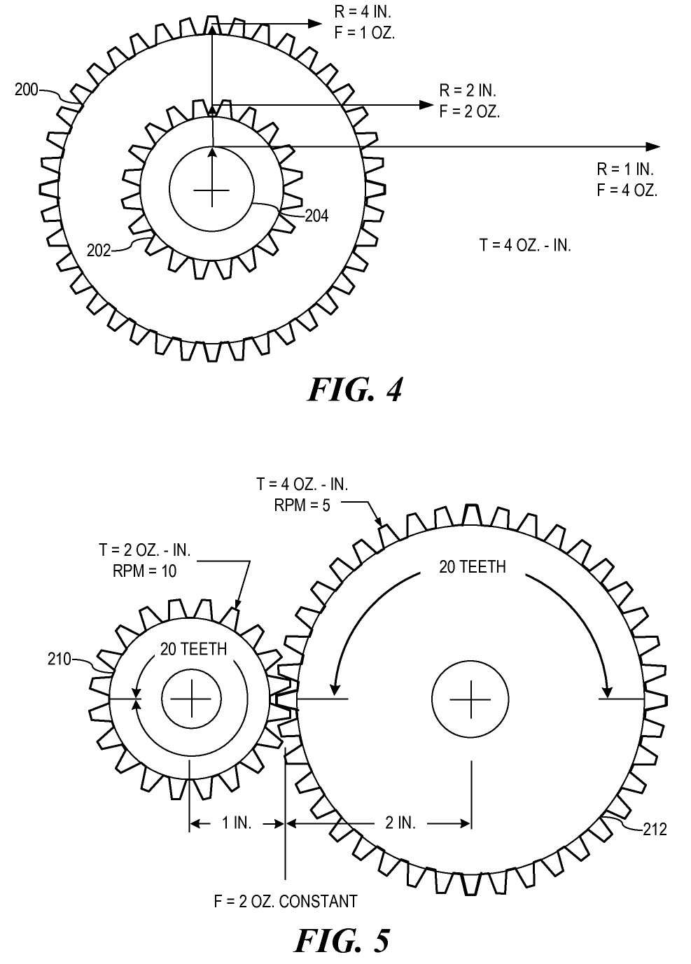

In addition to transferring torque between the first receptacle 120 and the second receptacle 130, the torque may be amplified through use of gears of varying size. FIG. 4 depicts torque being a constant at 4 ounce-inches for all gears shown fixed to a shaft. In this example, gear 200 has a 1 ounce force applied and a radius of 4 inches; gear 202 has a two ounce force applied and a 2 inch radius; and shaft 204 has a four ounce force applied and a one inch radius. Applying a force of 1 ounce to the gear 200 effects an output torque of four ounce inches to the shaft 204 which is the same torque applied to the gear 200. Thus, the torque has not been amplified in this example.

Conversely, the use of gears in combination may provide a mechanical advantage by increasing the circumferential output torque from the circumferential input torque. Error! Reference source not found. demonstrates how gears can be used to amplify the input torque. For example, applying a force of 2 ounce to a gear 210 with the one inch radius produces a two ounce-inches torque which transfers to a larger gear 212 on the right producing four ounce-inches of torque. Hence, there is a torque increase of 2:1. Torque ratios are usually stated as:
driven-gear: driver-gear
   wherein the driven-gear is the gear being driven (in our example the gear 212 on the right) by a driver-gear, the gear 210 on the left.

Referring back to FIG. 3, second drive gear 154, as a driven gear, may have a greater thread radius than either the first drive gear 152, as a driving gear, or the intermediate gear 150 thereby imparting amplification of torque applied to the first drive gear 152. Thus, it should be understood by a person of ordinary skill in the art that a coupling a driving gear to a driven gear having a relatively larger radius will generally result in amplification of the input torque.

In certain embodiments, the output direction of rotation of the second drive gear 154 may be the same as the input direction of rotation of the first drive gear 152 where the intermediate gears 150 are odd in number. For example in FIG. 3, there may be one intermediate gear 150. The counter-clockwise rotation of the second drive gear 152 may produce clockwise rotation of the intermediate gear 150, which then may produce counter-clockwise rotation of the first drive gear 154. In this way, counter-clockwise rotation of a ratchet drive apparatus (not shown) coupled to the second receptacle 130 produces counter-clockwise rotation of the second drive gear 154 in the case of unscrewing or loosening an obstructed bolt or nut having right-handed threads. Conversely as shown in FIG. 3, clockwise rotation of a ratchet drive apparatus (not shown) apparatus coupled to the second receptacle 130 may produce clockwise rotation of an obstructed bolt or nut in the case of screwing-in or tightening an obstructed bolt or nut having right-handed threads.

FIG. 3 also illustrates that the tool 100 may further comprise a pawl assembly 172. The pawl assembly 172 may be comprised of a lever member 174 coupled to a spring member 176 (not shown). As shown in FIG. 3, the pawl assembly 172 may couple to the intermediate gear 150 so that the lever member 174 rotates about the same axis of rotation as the intermediate gear 150. In other embodiments not shown where there are multiple intermediate gears are employed, the pawl assembly 172 may couple to the intermediate gear 150 that is most proximal to the to the first drive gear 152. It is to be understood by persons of ordinary skill that the pawl assembly 172 may couple to a location on the tool 100 that is proximal enough to the first drive gear 152 that the lever member 174 may engage the teeth of the first drive gear 152.

Referring to FIG. 3, the pawl assembly 172 may restrain rotation of the first drive gear 152 and the second drive gear 154 to a first direction in order to prevent at least some inadvertent backward motion in a second direction that may be opposite to the first direction. An end of the lever member 174 may engage the teeth of the first drive gear 152 and be configured so that the end of the lever member 174 slides away and retracts in the teeth of the first drive gear 152 when the second drive gear 154 receiving a ratchet drive apparatus handle (not shown) rotates in the first direction. The spring member 176 may assist to retract the end of the lever member 174 back to engage the gear teeth of the second drive gear. On the other hand, when the second drive gear 154 may rotate in the second direction the end of the lever member 174 may engage the teeth of the gear 154 in a configuration that prevents sliding of the end of the lever member 174 and prevents rotation of the second drive gear 154 and thus the first drive gear 152.

The tool 100 may be flipped from the second member 108 facing toward the bolt 20, such that the first member 106 faces toward the bolt 20. Flipping the orientation of the tool 100 from one position to another may allow for rotation of the socket insert 122 in the opposite direction resulting in a configuration for the tool 100 that may tighten the bolt 20 rather than loosen the bolt 20. The pawl assembly 172 may then prevent backward motion of the second drive gear 154 in the opposite direction of rotation of the driving gear.

Turning now to FIG. 6, there is shown one embodiment of the tool 100 with the linkage feature 155′ comprising the first drive gear 152 rotably coupled to the second drive gear 154 by a chain 156. In this embodiment, chain links of chain 156 may mesh with the teeth of the first drive gear 152 and second drive gear 154. A torque applied to the first drive gear 142 may then be transferred via the chain 156 to the second drive gear 152. The direction of rotation of the first drive gear 152 may also be maintained through implementation of the chain 155′ without requiring an intermediate gear.

Also illustrated in FIG. 6 is an alternative embodiment of the pawl assembly 172. In this embodiment, the lever member 174 and spring member 176 is rotably coupled to the body 102 proximal to the first drive gear 152 so that the end of the lever member 172 engages the teeth of the drive gear 152.

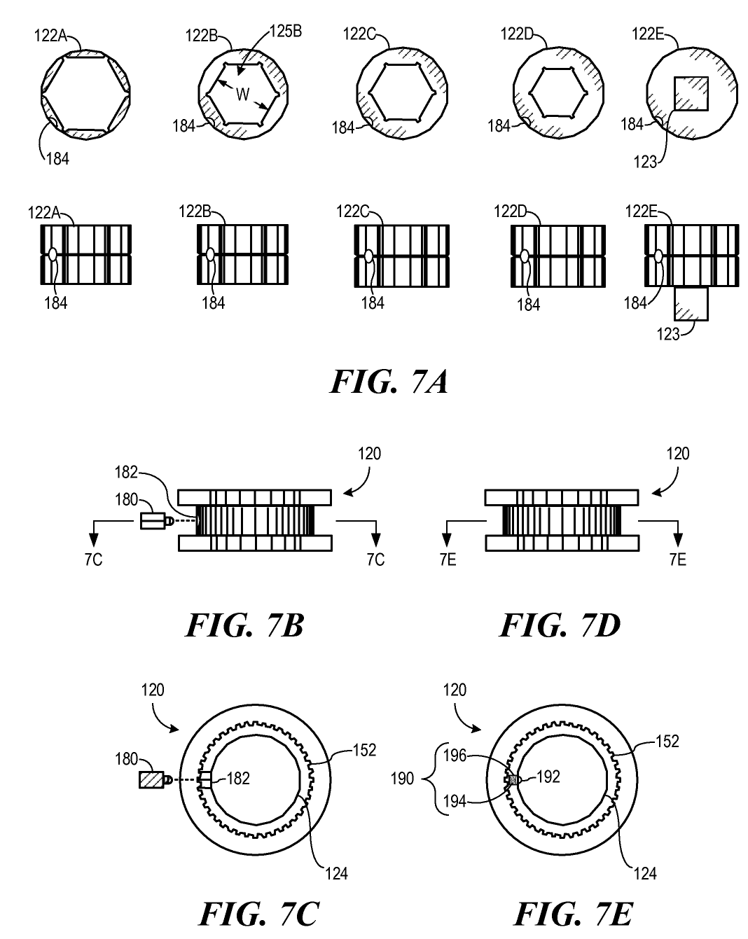

Illustrated schematically in FIG. 7A are shown embodiments of variously-sized socket inserts (shown as 122A-E) shown as a top view and corresponding side view that can be mounted into the first receptacle of the tool 100. The socket insert 122B, by example, may be configured to mount in the pocket 124 of the first receptacle 120 as described in FIGS. 7B-7E. The pocket 124 may then receive the socket insert 122B, for example, where the socket insert 122B comprises a corresponding 18 sided polygon shape, or other corresponding shape, fitting into the pocket 124.

FIG. 7A depicts an alternative embodiment of the socket insert 122E. The socket insert 122E as comprising an adapter member 123 for use in conjunction with a standard socket (not shown). The standard socket (not shown) may couple to the adapter member 123 at one end and couple to the bolt 20 (as shown in FIG. 1) at another end. The adapter member 123 may comprise a square shape or other suitable shape for use in coupling to various tool such as torque wrenches, flat wrenches, ratchets, drills and other torque devices which may be a commonly.

Illustrated in FIGS. 7B and 7C are shown a side view of the first receptacle 120 with a pin member 180 for coupling the socket insert 122B, for example as shown in FIG. 7A. The first receptacle 120 may comprise a pocket 124 for receiving the socket insert 122 (as shown in FIG. 7A). The pocket 124 may comprise a bore shaped generally as an 18-sided polygon passing through the first receptacle 120.

Referring to back FIG. 7A, the socket insert 122B may in part comprise a bore 125B for receiving the head of the bolt 20, as shown in FIG. 1. The bore 125B may comprise a variety of shapes for receiving the bolt 20, such as a hexagon, a polygon, a star shape, or other configuration for transferring torque. The bore 125B may be sized with size W according to many different diameters, including the standard English unit and metric unit sizes commonly used.

In the embodiment shown in FIGS. 7B and 7C and referring to FIG. 7A, the socket insert 122B may be secured for rotation in the pocket 124 of the first receptacle 120 by a pin 180. The pin 180 may pass through a bore 182 in the first receptacle 120 and may be configured to at least partially slidingly insert into the socket insert 122B, for example. In some embodiments, the pin 180 or other known methods such as welding may permanently couple the socket insert 122B into the pocket 124. Alternatively, in other embodiments the pin 180 may be coupled to a spring or other retraction mechanism (not shown) that allows the pin 180 to be removed from the socket insert 122B so that another socket insert, such as those described in FIG. 7A, may be coupled to the tool 100 (as shown in FIG. 1).

In the embodiments shown in FIGS. 7D and 7E and referring to FIG. 7A, there is shown another embodiment of the first receptacle 120. The first receptacle 120 may comprise a bearing assembly 190 comprising a ball bearing 192 coupled to a spring 194 which may be housed in a recess 196 in an inner wall of the pocket 124. The bearing assembly 190 may provide a mechanism to removably hold the socket insert 122B inside the pocket 124. The user may insert the socket insert 122B having a bore 125B with a size and shape suitable for actuating the bolt 20 (not shown). The socket insert 122B may comprise a recess 184 for receiving the pin 180 (shown in FIGS. 7B and 7C) or for receiving the bearing 192 of the bearing assembly 190 (shown in FIGS. 7D and 7E).

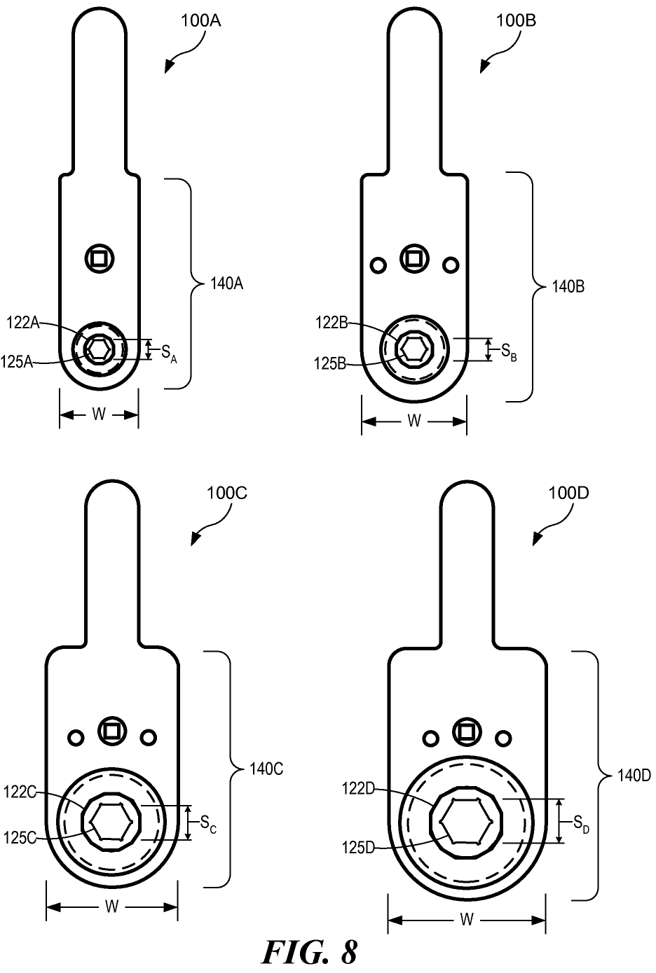

Referring now to FIG. 8, there is shown embodiments of the tools 100A, 100B, 100C, and 100D. Referring to tools collectively, where the head portions 140A, 140B, 140C, and 140D have been varied to show that the embodiments may be part of a set where each tool of the set has a different bore size S for the respective socket insert, for example 122A. In addition, the width W of each tool in the set may vary with the bore size S so that, for example, the tool 100A having a relatively smaller bore 125A size of the insert 122A will have a smaller head portion size W relative to tool 100B, having a smaller bore 125B size S of the insert 122B. Also, shown in FIG. 8 is a third and fourth embodiment of the tool 140C showing that the relative head portions 140C and 140D may be sized differently given a different bore 125C and 125D size S. The varying head portion 140C and 140D size W may allow the tool set 100A, 100B, 100C, and 100D to have different abilities to slide into confined spaces where obstructions may block access from other conventional ratchet tools.

Although only a few exemplary embodiments of this disclosure have been described in detail above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. Accordingly, all such modifications are intended to be included within the scope of this disclosure.

I claim:

1. A tool comprising:
a body portion;
a first receptacle rotatably mounted on the body portion for applying torque received from a second receptacle;
wherein the second receptacle is rotatably mounted on the body portion for receiving a torque; and
wherein the first receptacle is spaced from the second receptacle on the body portion; and
a torque transfer means for transferring and amplifying torque received by the second receptacle to the first receptacle.

2. The tool of claim 1 wherein the torque transfer means comprises two or more gears coupled to the first and second receptacles for transferring and amplifying torque received by the second receptacle to the first receptacle.

3. The tool of claim 2, wherein the torque transfer means further comprises gear coupling means for transferring torque between the two or more gears coupled to the first and second receptacles.

4. The tool of claim 3, wherein the gear coupling means comprises a chain.

5. The tool of claim 3, wherein the gear coupling means comprises interlocking teeth of the two or more gears coupled to the first and second receptacles.

6. The tool of claim 3, wherein the gear coupling means comprises a chain and engaging teeth of the two or more gears.

7. The tool of claim 1, further comprising body securing means for securing the tool against rotation of the body of the tool while torque is applied to the second receptacle.

8. The tool of claim 7, wherein the body securing means comprises an adjustable clamping bracket secured to the body.

9. The tool of claim 7, wherein the body securing means comprises one or more pins extending from the body substantially parallel to the axis of rotation of the first and second receptacles.

10. The tool of claim 1, further comprising a handle portion for positioning the first receptacle to engage a torque receiving member.

11. The tool of claim 2, wherein the two or more gears further comprise:
a driven gear rotatably coupled to the first receptacle;
a driving gear rotatably coupled to the second receptacle; and
an odd number of intermediate gears rotatably coupled together and to drive gear and to the driven gear, such that a rotation of the drive gear in a first direction results in a rotation of the driven gear in the first direction.

12. The tool of claim 1, wherein the second receptacle comprises a detachable insert having a bore for coupling to a torque receiving member.

13. A tool comprising:
a body portion;
a first receptacle rotatably mounted on the body portion for applying torque received from a second receptacle;
the second receptacle rotatably mounted on the body portion for receiving a torque;
two or more gears coupled to the first and second receptacles for transferring and amplifying torque received by the second receptacle to the first receptacle;
one or more pins for securing the body portion extending from the body substantially parallel to the axis of rotation of the first and second receptacles;
wherein the first receptacle is spaced from the second receptacle on the body portion;
a handle portion for positioning the first receptacle to engage a torque receiving member;
wherein the two or more gears comprise a drive gear rotatably coupled to the first receptacle, a driving gear rotatably coupled to the second receptacle; and an odd number of intermediate gears rotatably coupled together and to drive gear and to the driven gear, such that a rotation of the drive gear in a first direction results in a rotation of the driven gear in the first direction; and
wherein the two or more gears further comprise interlocking teeth of the two or more gears coupled to the first and second receptacles.
